(19) United States
(12) Patent Application Publication
(10) Pub. No.: US 2010/0125504 A1
(43) Pub. Date: May 20, 2010

(54) PRODUCT OR SERVICE COMPARISON NOTIFICATION SYSTEM AND METHOD

(76) Inventor: Riaz Ahmed Agha, London (GB)

Correspondence Address: DICKSTEIN SHAPIRO LLP, 1825 EYE STREET NW, Washington, DC, 20006-5403, US

(21) Appl. No.: 12/272,474

(22) Filed: Nov. 17, 2008

(51) Int. Cl. G06Q 30/00; G06F 7/06; G06F 15/16; H04L 9/32; G06F 17/30

(52) U.S. Cl. 705/14.55; 709/203; 726/7; 709/206; 707/E17.141; 707/E17.044; 707/E17.014; 705/14.73

(57) ABSTRACT

A notification system and method for providing a notification of comparison data for products or services to users for display on a user's computer. User notification data is stored for each of a plurality of users, user notification data comprising user data related to a user, type data identifying at least one type of product or service of a interest to the user, parameter date comprising parameters required for the comparison of data products or services of a product or service type of interest to the user, and temporal data indicative of when the user requires a notification. The user notification data is read to determine when to determine product or service comparison data by sending a query based on the type data and the parameter data to at least one product or service data source. Notification data is generated for display on a user's computer. The notification data includes the comparison data and a selectable link for each product or service compared in the comparison data. The selectable link directs the user's computer to send a request or apply for the product or service. The notification data for each user is transmitted in dependence upon the user data.

### FIELD OF THE INVENTION

The present invention generally relates to a system and method for generating a notification for a product or service comparison.

### BACKGROUND OF THE INVENTION

When a range of products or services are offered in a marketplace consumers wish to identify a product or service which best meets their needs. The requirements will include certain parameters that define the required product or service and where there is more than one product or service which meets these requirements, the consumer is then generally most interested in the product of service which is of the lowest cost or one which satisfies a person's need or requirement.

The Internet provides an environment which enables multiple products or service providers to offer their products or services easily. Comparison websites have been developed to allow easier selection of a type of product or service and to enter product or service parameters for a comparison to be carried out. The consumer is then able to select from amongst the comparison results to choose a product or service they wish to purchase, subscribe to or apply for.

It is an objection of the present invention to provide an improved system and method for providing product or service comparison data.

A first aspect of the present invention provides a notification system for providing a notification of comparison data for products or services to users for display on a user's computer. The system comprises a storage arrangement to store user notification data for each of the plurality of users, the user notification data comprising user data related to a user, type data identifying at least one type of product or service of interest to the user, parameter data comprising parameters required for the comparison of data for products or services of a product or service type of interest to the user, and temporal data indicative of when the user requires a notification; a comparison arrangement to read the user notification data to determine when to determine product or service comparison data by sending a query based on the type data and parameter data to at least one product or service data source; a notification arrangement to generate notification data for display on a user's computer, the notification data including the comparison data and a selectable link for each product or service compared in the comparison data, the selectable link directing the user's computer to send a request for the product or service; and a transmission arrangement to transmit the notification data for each user in dependence upon the user data.

The request for the product or service can comprise a request to purchase the product or service, a notification of interest to purchase the product or service, or an application for the product or service.

Another aspect of the present invention provides a notification client apparatus for receiving product or service comparison notification data from a notification system The apparatus comprises a network interface module to communicate with the client notification system over a network to receive the notification data; a data store storing the notification data comprising data comparing products or services; an alert module to generate an alert to a user when the notification data is received; a user interface to allow a user to view the notification data, and to enter a selection of a product or service; and a control module to control the network module and the user interface module to transmit the selection to the notification system.

A further aspect of the present invention provides a notification system for providing a notification of comparison data for products or service for users for display on a user device. The system comprises a storage arrangement to store user notification data for each of a plurality of users, the notification data comprising user data identifying a type of notification required by a user, type data identifying at least one type of product or service of interest to the user, parameter data comprising parameters required for the comparison data for products or services of a product or service type of interest to the user, and temporal data indicative of when the user requires a notification; a comparison arrangement to read the user notification data to determine when to determine product or service comparison data by sending a query based on the type data and parameter data to at least one product or service data source; a notification arrangement to generate notification data for display at a user device, the notification data including the comparison data; and a transmission arrangement to transmit the notification data for each user independent upon the type of notification defined in the user data.

A further aspect of the present invention provides a notification method to provide a notification of comparison data for products or service to users for display on a user's computer. The method comprises storing user notification data for each of a plurality of users, the user notification data comprising user data related to a user, type data identifying at least one type of product or service of interest to the user, parameter data comprising parameters required for the comparison of data for products or services of a product or service type of interest to the user, and temporal data indicative of when the user requires a notification; reading the user notification data to determine when to determine product or service comparison data by sending a query based on the type data and parameter data to at least one product or service data source; generating notification data for display on a user's computer, said notification data including the comparison data and a selectable link for each product or service compared in the comparison data, the selectable link directing the user's computer to send a request for the product or service; and transmitting the notification data for each user in dependence upon the user data.

Another aspect of the present invention provides a notification client method to receive product or service comparison notification data from a notification system. The method comprises communicating with the client notification system over a network to receive the notification data; storing the notification data comprising data comparing products or service; generating an alert to a user when the notification data is received; allowing a user to view the notification data and to enter a selection of a product or service; and transmitting the selection to the notification system.

A further aspect of the present invention provides a notification method to provide a notification of comparison data for products or services to users for display on a user device. The method comprises storing user notification data for each of a plurality of users, user notification data comprising user data identifying a type of notification require by a user, type data identifying at least one type of product or service of interest to the user, parameter data comprising parameters required for the comparison of data for products or services of a product or service type of interest to the user, and temporal data indicative of when the user requires a notification; reading the user notification data to determine when to determine product or service comparison data by sending a query based on the type data and the parameter data to at least one product or service data source; generating notification data for display at a user device, the notification data including the comparison data, and transmitting the notification data for each user in dependence upon the type of notification define in the user data.

Another aspect of the present invention provides a comparison system for providing a comparison of products or services to users. The system comprises a comparison arrangement to determine product or service comparison data by comparing data on products or services; a display generation arrangement to generate display data for display, the display data including the comparison data and a selectable link for each product or service compared in the comparison data, the selectable link sending a request for the product or service; and a monitoring arrangement to monitor selections of the selectable links by users for the comparison data; wherein the comparison arrangement is adapted to modify the determination of the comparison data in dependence upon the monitored selections.

Another aspect of the present invention provides a comparison method to provide a comparison of products or services to users. The method comprises determining product or service comparison data by comparing data on products or services; generating display data for display, the display data including the comparison data and a selectable link for each product or service compared in the comparison data, the selectable link sending a request for the product or service; and monitoring selections of the selectable links by users for the comparison data; wherein the determination of the comparison data is modified in dependence upon the monitored selections.

Another aspect of the present invention provides a comparison system for providing a comparison of products or services to users. The system comprises a comparison arrangement to determine product or service comparison data by comparing data on products or services; a display generation arrangement to generate display data for display, the display data including the comparison data and a selectable link for each product or service compared in the comparison data, the selectable link sending a request for the product or service; and a monitoring arrangement to monitor selections of the selectable links by users for the comparison data; wherein the display generation arrangement is adapted to modify the generation of the display data in dependence upon the monitored selections.

Another aspect of the present invention provides a comparison method to providing a comparison of products or services to users. The method comprises determining product or service comparison data by comparing data on products or services; generating display data for display, the display data including the comparison data and a selectable link for each product or service compared in the comparison data, the selectable link sending a request for said product or service; and monitoring selections of the selectable links by users for the comparison data; wherein the generation of the display data is modified in dependence upon the monitored selections.

The present invention can be implemented in hardware and in software or in a combination of both hardware and software. Thus the present invention encompasses a storage medium storing computer readable code for controlling a computer to carry out the method, a computer program for controlling a computer to carry out the method, and a signal carrying computer readable code for controlling a computer to carry out the method.

### BRIEF DESCRIPTION OF THE DRAWINGS

FIG. 1 is a schematic diagram of a comparison notification arrangement in accordance with one embodiment of the present invention;

FIG. 2 is a schematic diagram of the comparison notification server of FIG. 1 in more detail;

FIG. 3 is a schematic diagram of the user's computer of FIG. 1 in more detail;

FIGS. 4a and 4b are a flow diagram illustrating the operation of the arrangement of FIG. 1 in accordance with one embodiment of the present invention,

FIG. 5 is a flow diagram illustrating the further steps of the selection process following on from the process FIGS. 4a and 4b in accordance with one embodiment of the present invention;

FIG. 6 is a flow diagram illustrating the verification process in accordance with one embodiment of the present invention;

FIG. 7 is a flow diagram illustrating the automatic log in process in accordance with one embodiment of the present invention;

FIG. 8 is a flow diagram illustrating the comparison process in accordance with one embodiment of the present invention; and

FIG. 9 is a flow diagram illustrating the notification process in accordance with one embodiment of the present invention.

### DETAILED DESCRIPTION OF EMBODIMENTS OF THE INVENTION

Embodiments of the present invention are generally concerned with the problem of providing automated notifications of comparisons of products and services carried out in accordance with the user's requirements. The product services that a user may wish to prepare can for example comprise:

1. Insurance services such as life insurance, home insurance, and car insurance,

2. Mortgages and loans,

3. Credit cards,

4. Utility providers such as telephone service providers, mobile phone providers, energy suppliers (such as gas and electricity suppliers) and water suppliers.

5. Consumable products such as electronic goods, homeware goods, cars etc.

Thus the present invention is applicable to any type of product or service for which a comparison of product parameters can be performed.

In a first aspect of the present invention a notification system is generally provided such as by a computer server to notify users of comparison data available for products and services. The system stores user notification data for the users which comprises user data relating to a user, type data identifying at least one type of product or service of interest of user, parameter data required for the comparison of data products or services and temporal data indicative of when a user requires a notification. A user can indicate that they require to receive a notification of a comparison periodically such as every month, or at a certain date in the future, such as when a user's insurance is due for renewal. This indicates the date at which the comparison notification is to be delivered to the user. The user can also indicate a preferred time period for the delivery of the notification to the user. Also, the user data can indicate the preferred type of notification required by the user such as by e-mail, by SMS, by the Web, or by use of a bespoke client application.

The system operates to read the stored user notification data for all the users to determine when a product or service comparison should be undertaken in dependence upon the temporal data for the users. In order to perform the comparison a query is constructed for each user requiring a comparison based on the type data and parameter data for each user. The query is then transmitted to at least one product or service data source.

Notification data for display on a user's computer is generated to include the comparison data and a selectable link for each product or service compared in the comparison data. The selectable link directs the user's computer to send a request for the product or service. The notification is transmitted to each user based on their user data. Thus, for example, user data can define an e-mail address or some other form of address to which the notification data is to be sent. Also, user data can define the preferred type of notification e.g. e-mail, SMS, Web, or bespoke client application and thus the notification is delivered in accordance with that requirement. Where the notification is delivered as an SMS message or plain text email, a selectable link is not present and the notification simply includes summary information to allow a user to access the notification by other means e.g. via the Web.

The selectable link for each product or service can comprise a link to a product or service provider's computer or a link back to the notification system. Where the link is back to the notification system, the notification system can redirect the user's selection to a third party server or a product or service provider's server whereby the third party or product or service provider's server can then communicate directly with the user's computer. An example of this implemented in Web technology comprises a Web redirection of a browser at the user's computer as is well known in the art. Alternatively, when the selection is received by the notification system it can pass on data on the selection to a third party server or a product or service provider's computer and return an acknowledgement message to the user's computer for example stating that their interest in or order of the product or service has been communicated and the user will be contacted to further progress the matter.

Where the user selection is received by the notification system, additional data stored at the notification system for the user can be added to the user selection and passed on to the third party server or product or service provider's server. For example, in a web implementation, where a user selects to access a web page to purchase a product or service, pages can be pre-populated with data from records of user data stored at the notification system.

In order to access the notification system a user's computer or user must be validated. Login data is received from the user computer either from an automatic source within the computer or entered manually by the user. This is received and checked at the notification system and used to identify the user for future notifications.

In one embodiment of the present invention a dedicated client application can be downloaded and stored on the user's computer. The dedicated client application communicates with the notification system and looks for new notification data for the user. The notification system can thus include a code store for storing the dedicated client application for download to the user's computer. The dedicated client application can generate an alert to the user on the user's computer when new notification data is received from the notification system.

In one embodiment of the present invention the user's computer implements a notification client apparatus for receiving product or service comparison notification data from the notification system. A network interface module is provided for communication with the notification system over a network such as the Internet, a wide area network, a local area network, a wireless network or a wired network. A data store stores the notification data which includes data on compared products and services. An alert module generates an alert to a user when the notification data is received. A user interface allows a user to view the notification data and to enter a selection or a product or service. The control module controls the network module and the user interface module to transmit the selection to the notification system. Thus in this embodiment a separate dedicated client application can provide an efficient and immediate means of communication between the notification system and the user.

In one embodiment the user can enter at least one of user data related to a user, type data identifying at least one type of product or service of interest to the user, parameter data comprising parameters required for the comparison of data for products or service for a product or service type of interest to the user, and temporal data indicative of when the user requires a notification. This data can be transmitted to the notification system for storage and use in the determination of notification data for the user.

In one embodiment the dedicated client application is capable of working both off-line and on-line. When the communication link to the notification system is unavailable, notification data previously received from the notification system is stored and available to the user. Also user interaction such as entered selections and entered data are stored for transmission to the notification system when communications are re-established. Thus the client application provides significant advantages for users using a device e.g. a computer or mobile phone that has intermittent connection over a network.

The process of determining comparison data can comprise at least one of: retrieving comparison data from a product or service data source providing the comparison data; and retrieving product or service data from a product or service data source providing the product or service data and processing the retrieved data to determine the comparison data. Thus where there is readily available comparison data for a product type this can simply be received and made available. When such comparison data is not available, the notification system can retrieve product or service data from a number of sources in order to compile comparison data.

The comparison data can include ranking data. This may already be available from the comparison data retrieved from the source, or it can be determined during the comparison process and added to the comparison data. The ranking can be based on a number of factors such as quality, certain feature capabilities, or price. Price is the most commonly used ranking factor.

Selections made by users of products or services in the notification data can be tracked over time. This data can be processed and used in the adjustment of the ranking data. Thus prior user behaviour can be used to influence the user selection.

In one embodiment all interactions of the user with the notification data or the client application are tracked. This data is stored and can be used to modify the notification data.

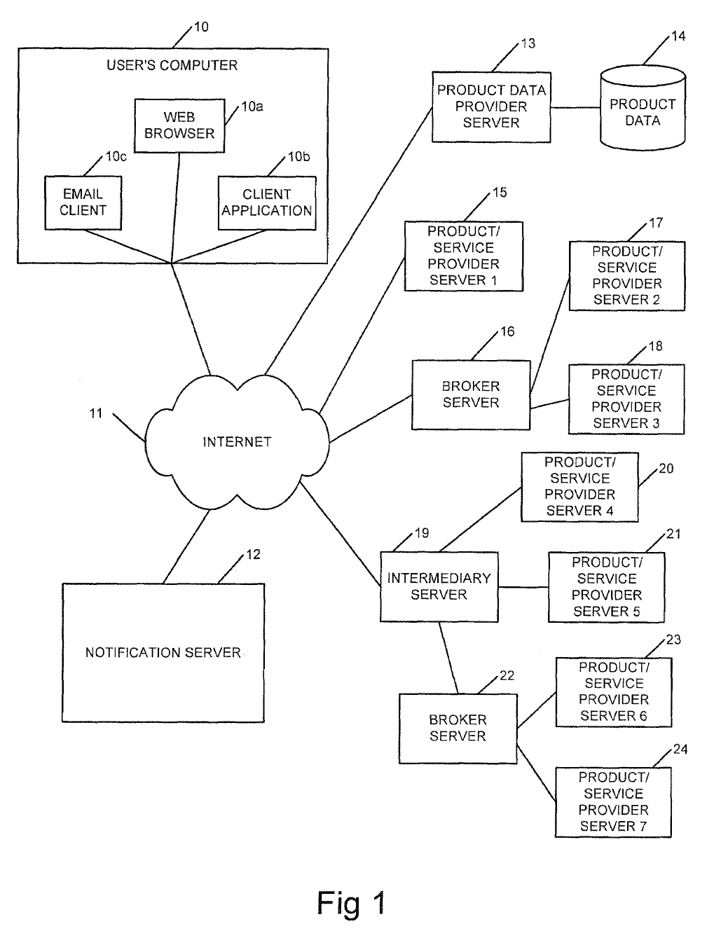

FIG. 1 illustrates a notification arrangement in accordance with a first embodiment of the present invention.

A user's computer 10 is connected via the Internet 11 to a notification server 12. The user's computer 10 can comprise any network-connected device such as a personal computer, personal digital assistant (PDA) or mobile phone. The Internet 11 can comprise network interconnection via wires or wireless. The network could also comprise a local area network, a wide area network or any other form of network.

The user's computer operates software modules for implementing this embodiment of the present invention. A web browser 10a, a dedicated client application 10b, and an e-mail client 10c are provided as software modules implemented on the user computer 10.

The notification server 12 is connected to the Internet 11 to provide the notification system functionality as will be described in more detail hereinafter. The notification server 12 can comprise any number of servers and computers connected in unison to provide the necessary functionality.

A product data provider server 13 is also connected to the Internet 11 and is provided with product data 14. The product data provider server 13 is a provider of comparison data for types of products or services. Such a known provider is DeFaqto. Thus the notification server 12 is able to access comparison data for types of products or services over the Internet from the product data provider server 13. Also connected over the Internet are various product/service provider servers 15, 17, 18, 20, 21, 23 and 24. In FIG. 1, only one product/service provider server 15 is illustrated connected directly to the Internet. However, many may be connected. Thus the notification server 12 can directly communicate with the product/service provider server 15. A broker server 16 is connected to the Internet and acts between the notification server 12 and product/service provider servers 17 and 18. The broker server 16 can be operated by a broker such as insurance broker whereby any selection by a user or a product or service provided by the product/service provider server 17 and 18 will be referred to the broker server 16.

An intermediary server 19 is also connected to the Internet and can provide an intermediate service between product/service providers 20 and 21 and a notification server and a broker server 22 and a notification server 12. In turn, the broker server 22 acts as a broker for product/service provider service 23 and 24.

As can be seen from FIG. 1, product/service provider servers 15, 17, 18, 20, 21, 23 and 24 can be available to the notification server either directly or via one or more intermediaries.

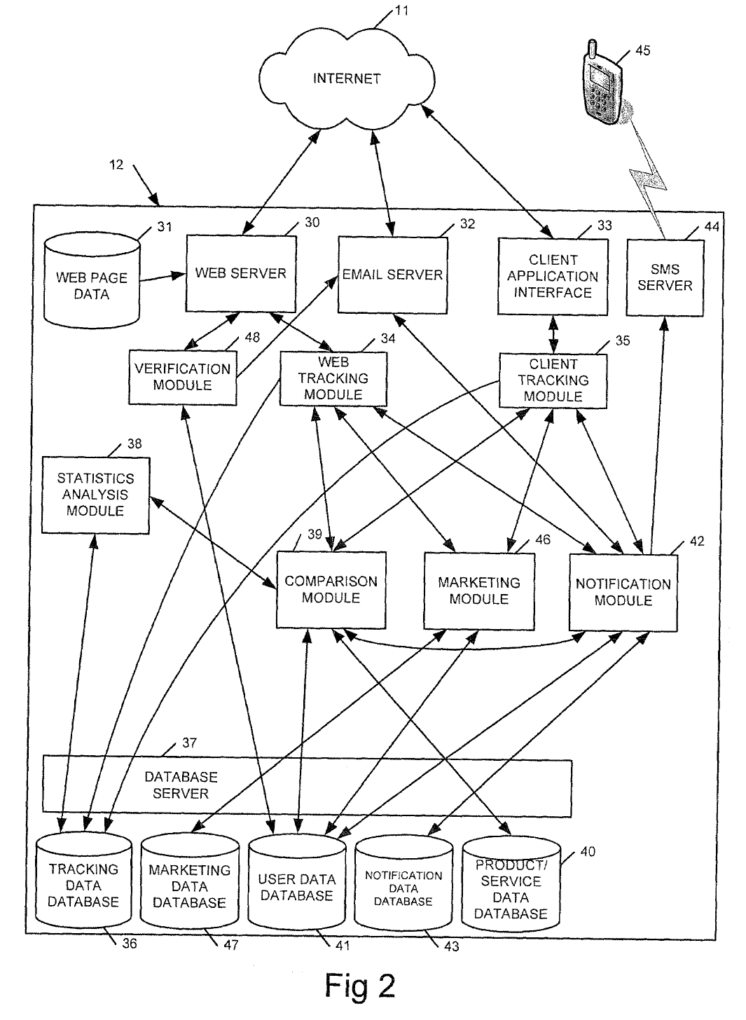

The notification server will now be considered in more detail with reference to FIG. 2.

A web server 30 is provided connected to the Internet 11. The web server is provided with web page data 31 which can comprise the data necessary to serve web pages i.e. both static and dynamic web page data. An e-mail server 32 is also provided connected to the Internet 11 for providing outgoing e-mail messages for verification of users as will be described in more detail hereinafter. A client interface module 33 is also provided connected to the Internet 11 for communication with the dedicated client application 10b on a user's computer 10. A web tracking module 34 and a client tracking module 35 are provided for tracking interactions responses from users through the web server 30 and client application interface 33 respectively. A tracking data database 36 is connected to the web tracking module 34 and the client tracking module 35 for the storage of tracking data. A statistics analysis module 38 is provided connected to the tracking database for the determination of statistical user behaviour for use in the modification of the comparison data as mentioned above. A comparison module 39 is provided connected to the statistics analysis module 38 for performing comparison of product or service data. The comparison module 39 is connected to the product or service database 40 and a user data database 41 via the database server 37. The comparison module 39 is also connected to the web tracking module 34 and the client tracking module 35 for the sending of comparison data as part of the notification to the user. A notification module 42 is connected to the web tracking module 34, the client tracking module 35 and the e-mail server 32. The notification module 42 is also connected to the user data database 41 and a notification data database 43 via the database server. Also the notification module 42 is connected to the comparison module 39 for the formation of the notifications to be sent to the users. An SMS server 44 can also be provided in the notification server or provider independently. The notification module 42 communicates with the SMS server 44 for the sending of SMS notifications to user's mobile phones 45.

A marketing module 46 is provided for generating adding marketing material to the notifications. The marketing module 46 is connected to the Web tracking module 4 and the client tracking module 35 for noting user behaviour. A marketing data database 47 is connected to the marketing module 46 via the database server 37. The marketing module 46 is also connected to the user data database 41 via the database server 37. A verification module 48 is provided connected to the web server 30 and the user data database 41 for performing the verification process.

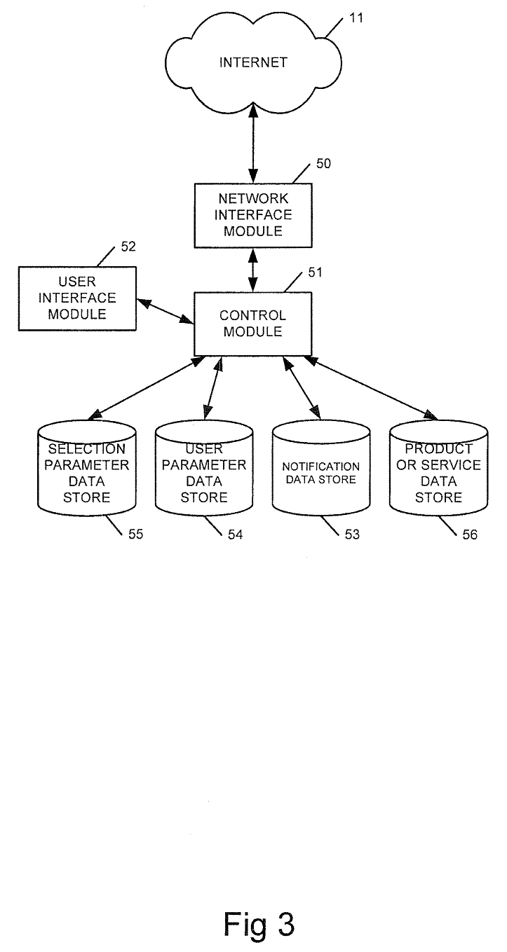

FIG. 3 illustrates the details of the client application 10b in more detail.

The client application includes a network interface module 50 for communication over the Internet 11 with the notification server 12. A control module 51 provides for control of the network interface module. A user interface module 52 is provided for generation of display notification data and for receiving user selections and user input data. User interface module 52 is under the control of the control module 51. Notification data received from the notification server 12 by the network interface module 50 is stored in the notification data store 53 by the control module 51. User parameter data input by the user using the user interface module 52 is stored in the user parameter data store 54 under the control of the control module 51. User selections made from the notification data using the user interface module 52 are stored in the selection data store 55. A product service data store 56 is also provided for storing product or service data input by a user to be used for receiving comparison notifications in the future.

The client application 10b is able to store notification data received from the notification server 12, user parameter data input by the user and selection data input by the user. Thus, if communications with the notification server 12 are interrupted, the client application 10b is able to continue providing functionality to the user until communications are restored.

The user data stored in the client application user parameter data store 54 and the user data database 41 of the notification server 12 can comprise personal information on the user including a user name and password for manual log in or a computer address or computer location for automatic log in. Also the user's email address can be stored for communication purposes. User data can also include information on whether the user is a verified user or unverified user. Only verified users have access to notifications. The notification process will be described in more detail hereinafter.

The user data can also include data indicating the preferred notification type e.g. by email, SMS or by web access. Also, it can indicate whether the user has downloaded the client application 10b. If so then their preferred notification type will be considered to be via the dedicated client application 10b. The user data can indicate not just whether the user has downloaded the client application 10b, but also whether they have selected to download it but not yet downloaded it.

As part of the data on the address of the user, data can be stored on the type of device that the user prefers to use for connection to the notification server 12. For example, whether they are using a PC or mobile device.

The user data can also include data indicating whether the user has elected to receive targeted advertisements.

The personal data will also include the input temporal data by a user indicating when a user wishes to receive notifications. The temporal data can indicate a period such as monthly, or it can indicate a set date in the future or a set date every year e.g. a date of renewal of a product or service such as a date for renewal for insurance. The temporal data can also indicate a preferred time of day for the receipt of the notification. The user may prefer to indicate the preferred time of day such as first thing in the morning when the notification is likely to receive more prompt attention.

The product or service data store 56 of the client application 10b and the product and service data database 40 of the notification server 12 store type data and product data. Type data indicates the type of product or service and parameter data indicates parameters of that product or service. For example, a type data can indicate whether the product or service is insurance and if so what type of insurance, a mortgage and if so what type or mortgage, a credit card, and if so what type of credit card, a loan, and if so what type of loan, or a utility and if so what type of utility. The parameter data comprises data parameters for a particular type of product or service, for example car insurance, the data will include age, sex, driving experience, previous accidents, address etc. The specific parameter data is used when performing a comparison of products or service of a particular type from different providers.

The notification data store 53 of the client application 10b and the notification data database 43 of the notification server 12 store notification data to be sent to a user's computer or received at a user's computer respectively. The notification data comprises data comparing products or service of the same type from different providers. The comparison data can be ranked by certain factors such as quality, specification, or price: price being the most common form of ranking.

The tracking data database 36 in the notification server 12 stores data indicative of user interactions with the provided notification data. In fact, the tracking data also includes any interaction by a user via the website. This data can be analysed by the statistics analysis module 38 to modify the comparison data in the notification data. This will be described in more detail hereinafter.

The marketing data database 47 in the notification server 12 stores marketing data for addition to the notifications to be sent to the user if the user has opted to receive marketing data. The marketing data will include data that is aimed at particular demographic targets. The marketing module 46 uses the marketing data and the user data to determine suitable targeted marketing material to be sent to a user.

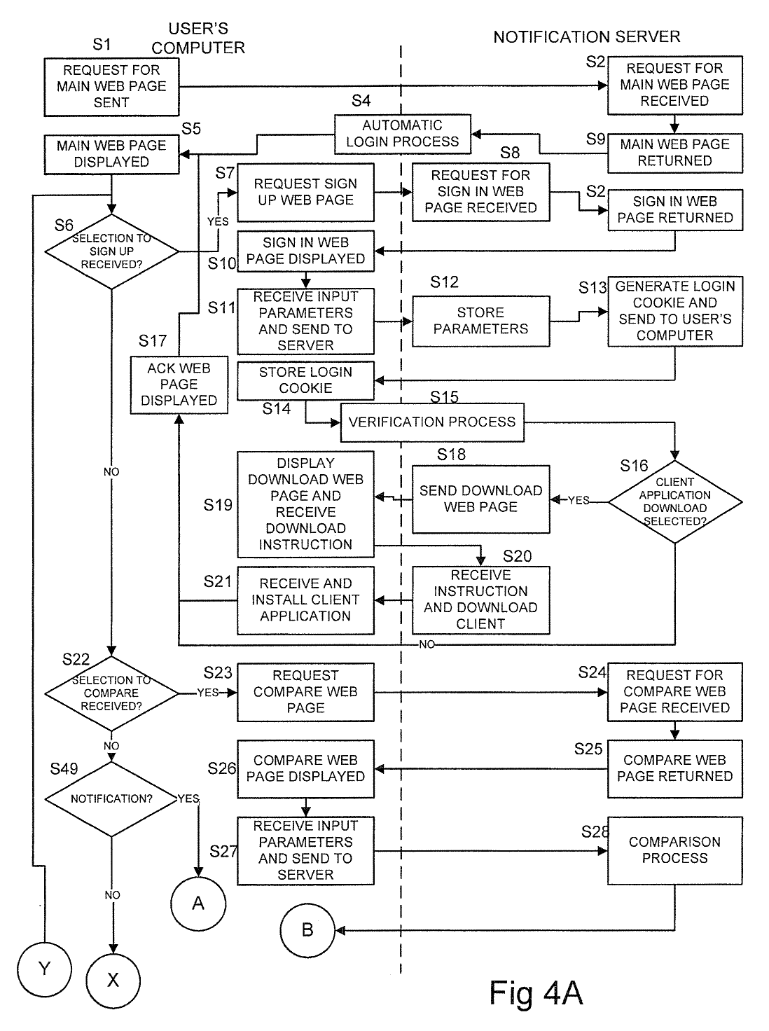

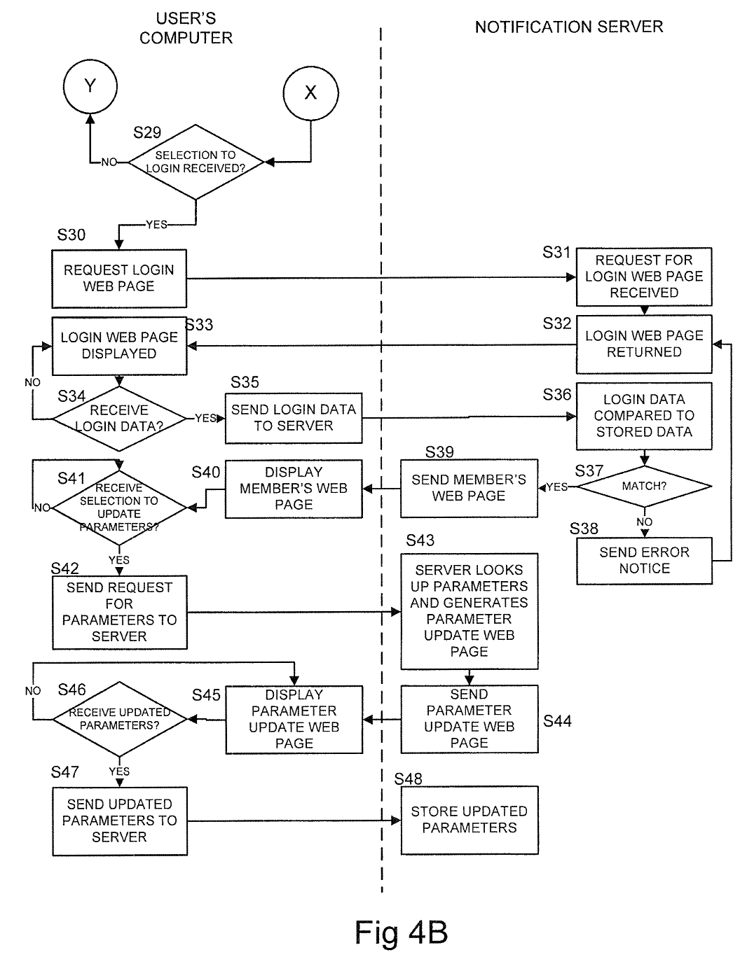

The operation of the notification arrangement, and in particular the user's computer 10 and the notification server 12 will now be described with reference to FIG. 4 to 9.

FIGS. 4a and 4b are a flow chart of the operation of the user's computer and the notification server when a user accesses the comparison notification website provided by the web server 30.

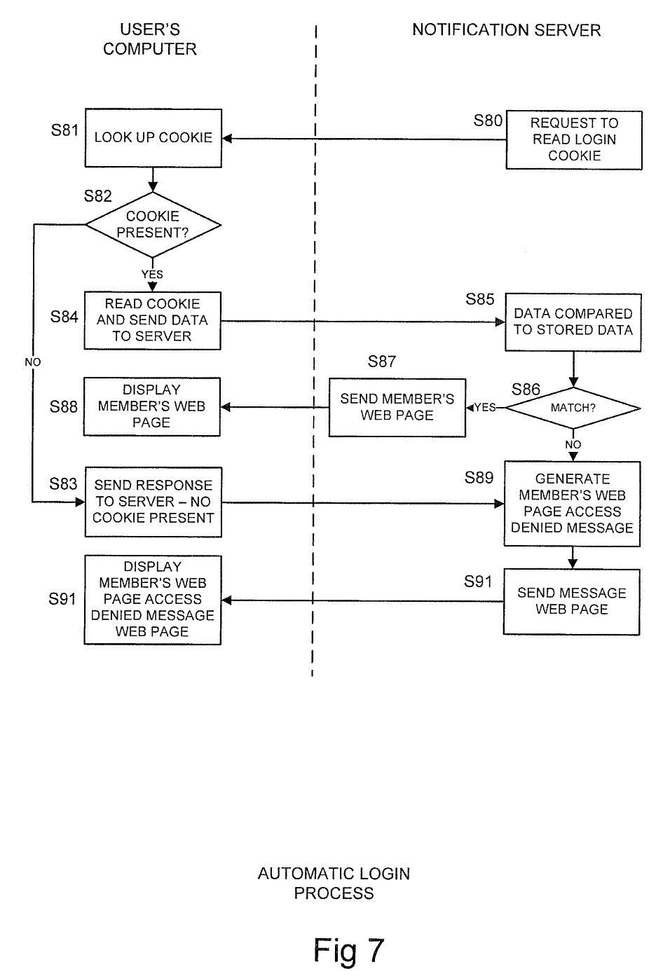

In step S1 a user uses a computer 10 to request the main web page for the comparison notification website. In step S2 the request is received at the notification server 12 and in step S3 the main web page is returned to the user's computer 10. At this stage of communication between the user's computer 10 and the notification server 12 an automatic log in process (step s4) can take place. This will be described in more detail hereinafter with reference to FIG. 7.

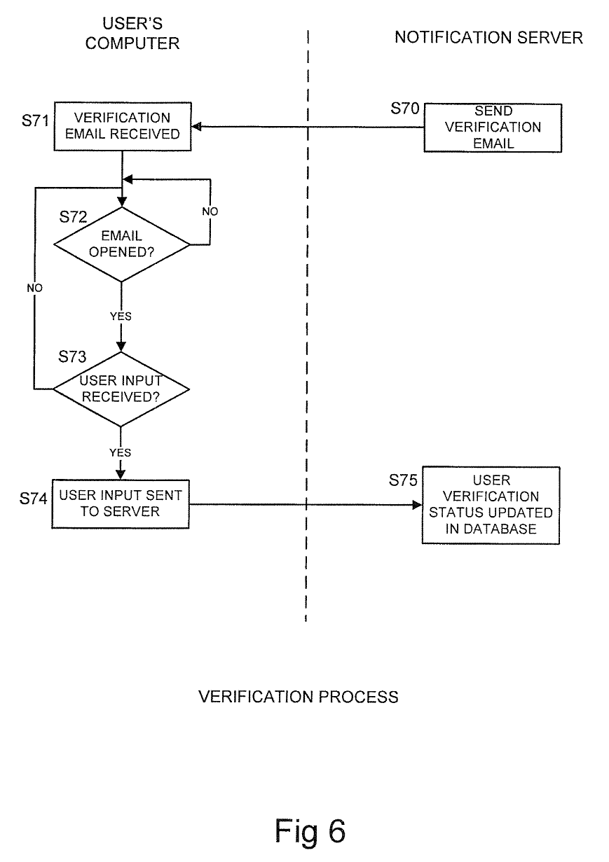

The main web page is displayed by the web browser 10a on the user's computer 10 (step S5). The user is then presented with options including to sign up for the service, a selection to compare a service or product, or an option to manually log in if required. In step S6 if a user selects to sign up for the service to become a member, a request for a sign up web page is sent from the user's computer 10 (step S7) which is received at the notification server 12 (step S8) and the sign in web page is returned to the user's computer 10 (step S9). The sign in web page is displayed (step S10) and a user then inputs the necessary parameters (step S11). These parameters include user data and product service data. The data is sent to the notification server where it is stored (step S12) in the user data database 41 and a product or service data database 40. In order to facilitate automatic log in and access to the member section of the web site in the future, a log in cookie is generated and sent to the user's computer (step S13). The cookie is received at the user's computer 10 and stored (step S14) a user verification process (step S15) can then take place as will be described in more detail hereinafter with reference to FIG. 6.

If the user has not elected to download the client application 10b (step S16) an acknowledgement of a web page is generated and sent to the user's computer (step S17) to acknowledge that the user's has signed up for the service. The process then returns to the display of the main web page (step S5).

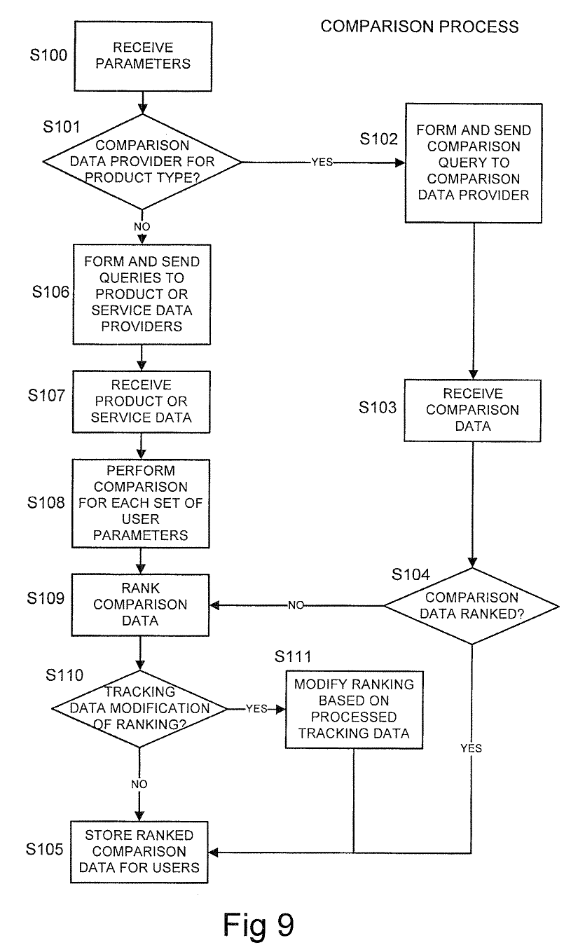

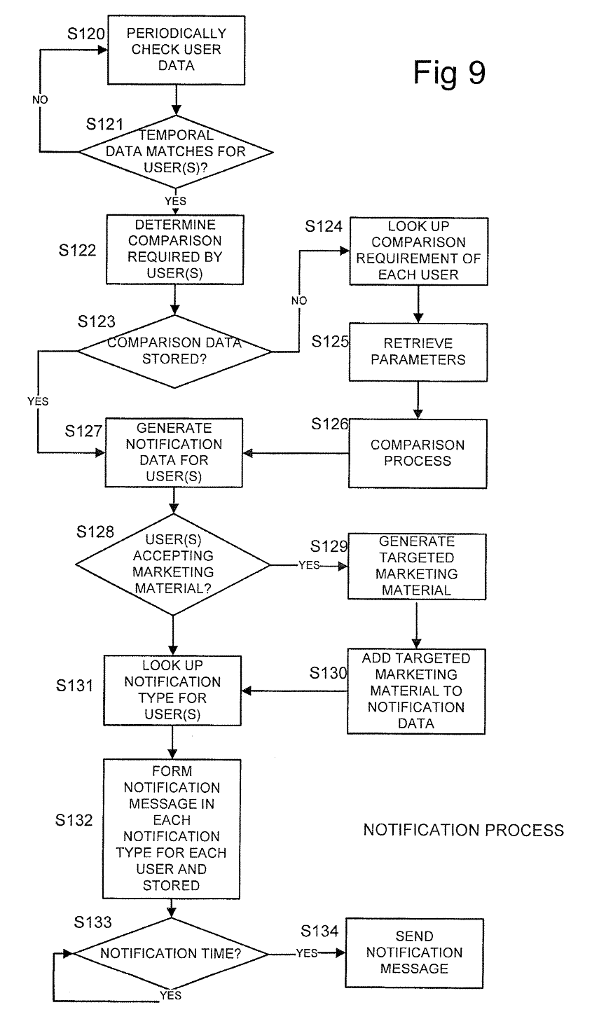

If the client has elected to download the client application 10b the notification server 12 sends a download web page to the user's computer 10 (step S18) where it is displayed to enable a user to select to receive the download (step S19). The instruction to receive the download is sent to the notification server where it is received and the client application 10b is downloaded to the user's computer (step S20). The user's computer 10 receives and installs the client application 10b (step S21). An acknowledgement web page is then generated by the notification server and displayed (step S17) to indicate that the service has been successfully signed up for and the process returns to display the main web page (step S5). On the main web page if the user selects to compare a product or service (step S22) a request for a compare web page is generated (step S23) and sent to the notification server. The notification server 12 receives the request (step S24) and returns the compare web page to the user's computer (step S25). On the user's computer 10 the compare web page is displayed (step S26) and the user can input parameters necessary for a comparison. These parameters include type later and parameter data, as well as some user data (step S27). The parameters are then transmitted to the notification server where the comparison process is carried out (step S28). The comparison process will be described in more detail hereinafter with reference to FIG. 9.

On the main web page if a user selects to log in (step S29) a request for the log in web page is transmitted to the notification server (step S30) where upon the notification server receives the request (step S31) and returns the log in web page (step S32). At the user's computer the log in web page is displayed (step S33) and a log in input from the user is awaited (step S34). The input log in data is sent to the server (step S35) where it is compared to stored user data (step S36). If the data does not match (step S37) an error notice is sent to the user's computer (step S38) and the process returns to display the log in web page (step S32 and S33).

If the log in data successfully matches the stored data (step S37) a member's web page is generated and sent to the user's computer (step S39). At the user's computer the member's web page is displayed (step S40) and a user input to select whether or not to update parameters is awaited (step S41). If a request to update the parameters is received it is sent to the server (step S42). The server looks up the already stored parameters in the user data database 41 and a product or service data database 40 and generates a parameter update webpage (step S43), which is then sent to the user's computer (step S44). At the user's computer the update web page is displayed (step S44) and updated parameters are awaited (step S46). Any updated input parameters are sent to the server (step S47) where they are stored (step S48) in the user data database 41 and the product or service data database 40 as appropriate.

Thus as can been seen in FIGS. 4a and 4b, when a user accesses the web page, they can sign up for the service and download the client application, during which the user data and product or service data for the user is entered and stored. They can also perform a straightforward comparison without having to sign up to the service. Further, they can log in and update their parameters in the user's data database 41 and the product or service data database 40. In this latter process, the manual log in may not be required if automatic log in has been successful (step S4).

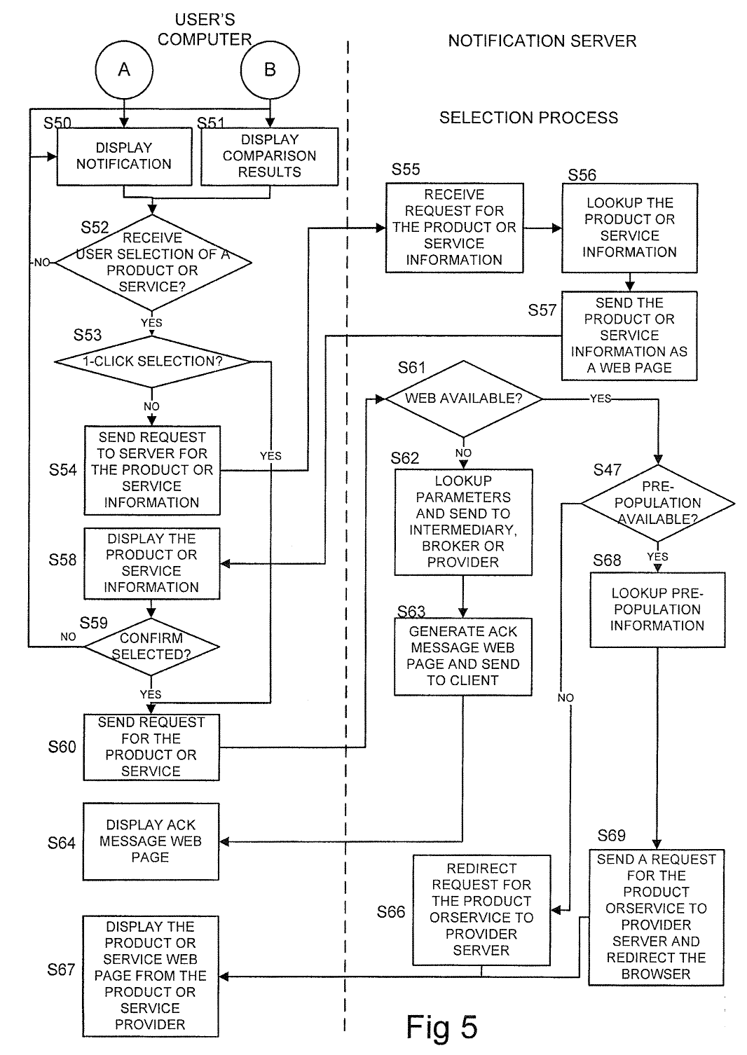

When a user is viewing the main web page if there is a notification (step S49) as can be seen in FIG. 5, the notification is displayed (step S50). Also at the end of the comparison process (step S28) as can be seen in FIG. 5, the comparison results are displayed (step S51). Thus, referring to FIG. 5 the process for allowing a user to select a product or service using the displayed notification or display comparison results will now be described.

A user selection of a product or service is awaited (step S52). The process provides for two types of selections: a one-click selection, which automatically connects or a tentative selection which requires the display of further information before a selection will be confirmed by a user. Thus in step S53 it is determined whether the user has made a one-click selection or not. If not, a request is generated and sent to the server for product or service information (step S54). The request is received and the product or service information is looked up (steps S55 and S56). The product or service information is then formed as a web page (step S57) and returned and displayed at the user's computer by the web browser (step S58). If the user does not confirm the selection (step S59) the process returns to the display of the notification or the display of the comparison results respectively (steps S50 or S51).

If the one-click selection is made (step S53) or the selection is confirmed (step S59) the request for the product or service is set to the server (step S60) at the server it is determined whether the product or service requested is available as a web selection (step S61) if not data in the user data database and product or service data database are looked up and sent to an intermediary, broker or provider (step 62). An acknowledgement message is then generated as a web page and returned to the client (step S63) where it is displayed (step S64). The acknowledgement message can indicate that the user's selection of a product or a service has been accepted and a representative will contact the user.

If a web service is available for the product or service (step S61) it is to determine whether a pre population of the data on the web site is available. If not the request for the web page form the user's computer which was sent to the notification server is redirected to the product or service providers server (step S66) and the user's computers web browser 10a is redirected to display the product or service webpage from product or service provider (step S67). In this way the intervention by the notification server in the request is transparent to the user. The notification server has however, been able to track the act that the selection has been made.

If it is determined that pre-population is available (step S65) data is looked up in the product or service data database 40 for the user data database 41 (step S68) for addition to the request to the product or service provider server. The request from the user is then forwarded to the product or service provider's server as a redirect request and the webpage is pre-populated with data (step S69). The web browser 10a of the user's computer 10 is thus redirected to display the product of service web page from the product or service provider with pre-populated data (step S67).

As can be seen this method enables a web based notification system to operate for web based notifications with links straight to the product or service provider where available or to enable the product or service to be requested via third parties using the capability of the notification server.

The verification process (step S15 of FIG. 4a) will now be described in more detail with reference to FIG. 6.

The purpose of the verification process is to verify that the user signing up for the process gives a correct e-mail address and it also gives a certain level of verification that the user is genuine.

The notification server sends a verification e-mail (step S70) to the e-mail address supplied by the user. At the user's computer the verification e-mail is received at the e-mail client 10C (step S71). The process waits until the e-mail is opened (step S72) and the user inputs the necessary response (stem S73). When the user inputs the necessary response, it is sent to the server (step S74) where the user verification status is updated in the user data database 41 (step S75). The automatic log-in process (step S4 of FIG. 4a) will now be described in more detail with reference to FIG. 7.

With the sending of the main web page to the user's computer a request to read the log-in cookie is sent (step S80). At the user's computer the log-in cookie is looked up (step S81) and if it is not present (step S82) a response is sent saying as such to the server (step S83) if a cookie is present the cookie is read and the data in the cookie is sent to the server (step S84). The data in the cookie is then compared to stored data in the user's data database 41 (step S85). If the data matches (step S86), the member's web page is returned (step S87) and it is displayed on the user's computer (step S88). If the data does not match (step S86) or there is no cookie to send (step S83) a member's web page access denied message is generated and sent to the user's computer (steps S89 and S90) for display at the user's computer (step S91). If the automatic log-on fails, the user is still able to access the main web page for limited functionality such as undertaking a comparison (step S22) or for locking on manually (step S29).

The comparison process (step S28 of FIG. 4a) will now be described with reference to FIG. 9.

The service data parameters are received (step S100). It is then determined whether there is a comparison data provider for the product type (step S101). If comparison data is available from the product data provider server 13 in FIG. 1 a comparison query is formed and sent to the provider server (step S102). The comparison data is received (step S103) and if it contains ranking data (step S104) the ranked comparison data is stored for users (step S105). If the comparison data is not ranked (step S104) a rank comparison process is undertaken (step S109) to generate ranking data for the comparison data and the ranking data is added to the comparison data. It is then determined whether the ranking is to be modified by tracking data (step S110). If not the rank comparison data is stored (step S105). If the ranking is to be modified by the tracking data (step S110) Step S111 a process for the modification of the ranking is undertaken and the modified ranking data stored with the comparison data in step S105.

If it is determined that comparison data is not available (step S101) queries are formed and sent to a number of product or service data providers (step S108). The received product or service data (S107) is processed for comparison data for each set of user parameters (step S108). Rank comparison data is then generated for ranking the comparison (step S109). If the ranking is to be modified by tracking data (step S110) the tracking data is used to modify the ranking (step S110) and the ranking data is then stored with the comparison data (step S105).

The modification of the ranking in this embodiment can comprise changing the order based on user's previous selections. For example, if in previous notification data for user's a particular product or service was ranked highly for many users but not selected, this would indicate a reluctance for users to select the product or service despite being ranked more highly. This can be used to move the product or service down future rankings. It can for example indicate a negative brand image for the product or service even though for example the ranking was based on price, users may prefer to pay slightly more for a product or service having a better brand image.

An addition or alternative to changing the ranking, the modification of the ranking data can include simply the addition of data such as an addition of number indicating the percentage of previous users who selected the product or service when ranked in the same position or higher. In other words, the display of the ranking can be modified based on previously tracking selections by users. Thus statistics on user acceptances influences the display of ranked results in future notifications.

The notification process will now be described in more detail with reference to FIG. 9.

The notification module 42 will periodically check the user data database 41 (step S120) to look for temporal data matches for users (step S121). When it is determined that it is an appropriate time for a notification for one or more users, the comparison that is required by the user or users is determined from the product or service database 40 (step S122). If there is recent comparison data stored for the product type (step 123) notification data for the users can simply be generated from the stored comparison data (step S127). If there is no recent stored comparison data the comparison requirement for each user is looked up (step S124) and parameters are retrieved (step S125). The comparison process is then performed (step S126) and the notification data for the users is generated (step S127).

It is then determined whether the users accept marketing material (step S128) by the marketing module 46 looking up data in the user data database 41. If the user does accept marketing material, targeted marking material is generated (step S129) by the marketing module 46 using the marketing data database 47. The targeted marketing material is then added to the notification data (step S130).

In order to transmit the notification data to the user, the type of notification required by the user is then looked up in the user data database 41 (step S131). The notification message including the notification data is then formed in each notification type for each user and stored (step S132). The notification module 42 will then determine at an appropriate notification time (step S133) for a user based on the temporal data in the user data database 41 when to send a notification message (step 134).

If a user receives a notification based on a notification type which is an SMS message or an e-mail of text type and not HTML type, a user cannot select a link. The notification is thus passive and requires the user to visit the service website. These forms of notification merely provide an alert which enable users to visit the user selectable notifications at the website.

In the above described embodiments, when a user responds to HTML based e-mail, it can include web base links which enables a user to select a link i.e. select the product or service and go straight to the process at step S50 in FIG. 5. If the e-mail is simply a text e-mail the user must log in and start the process at step S1 of FIG. 4a. Similarly for an SMS based notification, the user must log in the website at step S1 of FIG. 4a in order to make a selection in the web base notification.

Where the user's computer 10 uses the client application 10b, a notification is displayed by the client application and the user can select a product or service displayed by the client application 10b. The client application thus carries out the process of steps 50, 52, 53, 54, 58, 59, 60 and 64 or FIG. 5 in a non-web based environment. It is only at step S57 where there is a direct web link to the product or service provider that the client application calls the web browser to open and be redirected to the service or product provider.

It is possible for the client application 10b to have further functionality such as the capability of carrying out the comparison process of FIG. 9. However, this requires additional coding.

Although the embodiments of the present invention have been described with reference to the drawings implemented using web base technology, it would be understood to a skilled person in the art that the present invention is not limited to such technology and any equivalent functioning technology can be used.

In the embodiments described software code modules have been described performing specific functions. It will however be apparent to a skilled person in the art that any of the modules can be combined or divided further based on convenient coding requirements.

The present invention is intended to encompass any network based technology including both wired and wireless. The devices used for the notification server and the user's computer in the embodiment described above can comprise any suitable hardware comprising one or devices and any suitable combination of hardware and software to provide the functionality.

The present invention can be implemented in software and as such software can be provided on any suitable carrier medium comprising a storage medium such as a floppy disc, hard disc, CD ROM, DVD, or solid state memory device for example, or a signal such as an electrical, optical, microwave, electromagnetic, or acoustic signal for example. One such form of signal is a TCP/IP signal with a download of computer code over a network such as the Internet, wide area network or local area network.

What is claimed is:

1. A notification system for providing a notification of comparison data for products or services to users for display on a user's computer, the system comprising:
a storage arrangement to store user notification data for each of a plurality of users, the user notification data comprising user data related to a user, type data identifying at least one type of product or service of interest to the user, parameter data comprising parameters required for the comparison of data for products or services of a product or service type of interest to the user, and temporal data indicative of when the user requires a notification;
a comparison arrangement to read the user notification data to determine when to determine product or service comparison data by sending a query based on the type data and parameter data to at least one product or service data source;
a notification arrangement to generate notification data for display on a user's computer, said notification data including said comparison data and a selectable link for each product or service compared in said comparison data, said selectable link directing the user's computer to send a request for said product or service; and
a transmission arrangement to transmit said notification data for each said user in dependence upon the user data.

2 A notification system according to claim 1, wherein said notification arrangement is adapted to generate said notification data to include a selectable link for each product or service to a product or service provider's computer.

3. A notification system according to claim 1, including a receiving arrangement to receive a user's selection of a said selectable link, wherein said notification arrangement is adapted to generate said notification data to include a selectable link for each product or service to said notification system.

4. A notification system according to claim 3, wherein said notification arrangement is adapted to redirect the received user's selection to a third party server or a product or service provider's server, wherein said third party or product or service provider's server communicates directly with the user's computer.

5. A notification system according to claim 3, wherein said notification arrangement is adapted to send the received user's selection to a third party server or a product or service provider's server, and to return an acknowledgement message to said user's computer.

6. A notification system according to claim 4, wherein said notification arrangement is adapted to send said parameter data for selected product or service with the received user's selection to a third party server or a product or service provider's server.

7. A notification system according to claim 1, wherein said user data includes address data comprising at least one of an email address, a network address, or an IP address, and said transmission arrangement is adapted to transmit said notification data in accordance with said address data.

8. A notification system according to claim 1, including an arrangement for receiving user login data from the user's computer, wherein said user data includes user login data, and said transmission arrangement is adapted to transmit said notification data in dependence upon a matching of the received login data and the stored login data.

9. A notification system according to claim 1, wherein said notification arrangement is adapted to generate said notification data for display by a dedicated notification client application on said user's computer, and said transmission arrangement is adapted to transmit said notification data to said dedicated notification client application.

10. A notification system according to claim 9, including an application store storing code for implementing said notification client application on a said user's computer, wherein said transmission arrangement is adapted to transmit said notification client application to a said user's computer in response to a request from a said user's computer.

11. A notification system according to claim 9, wherein said code includes code for controlling the user's computer to monitor for notification data from the notification system, and to generate an alert to the user when notification data is received.

12. A notification system according to claim 9, wherein said notification arrangement is further adapted to generate an alert for transmission by SMS to a user's mobile to alert a user to the availability of said notification data for display on said user's computer.

13. A notification system according to claim 1, wherein said comparison arrangement is adapted to determine said product or service comparison data by at least one of:
retrieving comparison data from a said product or service data source providing said comparison data; and
retrieving product or service data from a said product or service data source providing said product or service data, and processing said retrieved data to determine said comparison data.

14. A notification system according to claim 13, wherein said retrieved comparison data includes ranking data.

15. A notification system according to claim 13, wherein said comparison arrangement is adapted to rank said comparison data and include ranking data in said comparison data.

16. A notification system according to claim 14, including a tracking arrangement to track user selections of said selectable links, wherein said comparison arrangement is adapted to adjust said ranking data based on said tracked user selections.

17. A notification system according to claim 1, including a tracking arrangement to track interactions by users in response to the display of said notification data, to store tracking data, and to modify said notification data for a said user in response to the stored tracking data.

18. A notification client apparatus for receiving product or service comparison notification data from a notification system, the apparatus comprising:
a network interface module to communicate with the notification system over a network to receive the notification data;
a data store storing said notification data comprising data comparing products or services;
an alert module to generate an alert to a user when said notification data is received;
a user interface to allow a user to view said notification data, and to enter a selection of a product or service; and
a control module to control said network module and said user interface module to transmit said selection to said notification system.

19. A notification client apparatus according to claim 18, wherein said control module is adapted to control said user interface to receive at least one of user data related to a user, type data identifying at least one type of product or service of interest to the user, parameter data comprising parameters required for the comparison of data for products or services of a product or service type of interest to the user, and temporal data indicative of when the user requires a notification; and said control module is adapted to control said network interface to transmit said at least one of user data, type data, parameter data and temporal data to said notification system.

20. A notification client apparatus according to claim 18, wherein said data store stores said selections, and said control module is adapted to detect when said network interface is unable to communicate with said notification system and to operate the client apparatus in an off-line mode whereby said selections are stored until said network interface is able to communicate with said notification system.

21. A notification client apparatus according to claim 19, wherein said data store stores said selections and said at least one of user data, type data, parameter data and temporal data, and said control module is adapted to detect when said network interface is unable to communicate with said notification system and to operate the client apparatus in an off-line mode whereby said selections and said at least one of user data, type data, parameter data and temporal data are stored until said network interface is able to communicate with said notification system.

22. A notification system for providing a notification of comparison data for products or services to users for display on a user device, the system comprising:
a storage arrangement to store user notification data for each of a plurality of users, the user notification data comprising user data identifying a type of notification required by a user, type data identifying at least one type of product or service of interest to the user, parameter data comprising parameters required for the comparison of data for products or services of a product or service type of interest to the user, and temporal data indicative of when the user requires a notification;
a comparison arrangement to read the user notification data to determine when to determine product or service comparison data by sending a query based on the type data and parameter data to at least one product or service data source;
a notification arrangement to generate notification data for display at a user device, said notification data including said comparison data; and
a transmission arrangement to transmit said notification data for each said user in dependence upon the type of notification defined in the user data.

23. A notification system according to claim 22, wherein said notification arrangement is adapted to generate said notification data to include selectable links in said comparison data, said selectable links including data for directing the user device to request said product or service.

24. A notification system according to claim 22, wherein said type of notification comprises one of a text message, an email, and a web page.

25. A notification method to provide a notification of comparison data for products or services to users for display on a user's computer, the method comprising:
storing user notification data for each of a plurality of users, the user notification data comprising user data related to a user, type data identifying at least one type of product or service of interest to the user, parameter data comprising parameters required for the comparison of data for products or services of a product or service type of interest to the user, and temporal data indicative of when the user requires a notification;
reading the user notification data to determine when to determine product or service comparison data by sending a query based on the type data and parameter data to at least one product or service data source;
generating notification data for display on a user's computer, said notification data including said comparison data and a selectable link for each product or service compared in said comparison data, said selectable link directing the user's computer to send a request for said product or service; and
transmitting said notification data for each said user in dependence upon the user data.

26. A notification method according to claim 25, wherein said notification data is generated to include a selectable link for each product or service to a product or service provider's computer.

27. A notification method according to claim 25, including receiving a user's selection of a said selectable link, wherein said notification data is generated to include a selectable link for each product or service to said notification system.

28. A notification method according to claim 27, including redirecting the received user's selection to a third party server or a product or service provider's server, wherein said third party or product or service provider's server communicates directly with the user's computer.

29. A notification method according to claim 27, including sending the received user's selection to a third party server or a product or service provider's server, and returning an acknowledgement message to said user's computer.

30. A notification method according to claim 28, including sending said parameter data for selected product or service with the received user's selection to a third party server or a product or service provider's server.

31. A notification method according to claim 25 claim, wherein said user data includes address data comprising at least one of an email address, a network address, or an IP address, and said notification data is transmitted in accordance with said address data.

32. A notification method according to any claim 25, receiving user login data from the user's computer, wherein said user data includes user login data, and said notification data is transmitted in dependence upon a matching of the received login data and the stored login data.

33. A notification method according to claim 25, wherein said notification data is generated for display by a dedicated notification client application on said user's computer, and said notification data is transmitted to said dedicated notification client application.

34. A notification method according to claim 33, including storing code in a code store for implementing said notification client application on a said user's computer, wherein said notification client application is transmitted to a said user's computer in response to a request from a said user's computer.

35. A notification method according to claim 33, wherein said code includes code for controlling the user's computer to monitor for notification data from the notification system, and to generate an alert to the user when notification data is received.

36. A notification method according to claim 25, including generating an alert for transmission by SMS to a user's mobile to alert a user to the availability of said notification data for display on said user's computer.

37. A notification method according to claim 25, wherein said product or service comparison data is compared by at least one of:
retrieving comparison data from a said product or service data source providing said comparison data; and
retrieving product or service data from a said product or service data source providing said product or service data, and process said retrieved data to determine said comparison data.

38. A notification method according to claim 37, wherein said retrieved comparison data includes ranking data.

39. A notification method according to claim 37, wherein including ranking said comparison data and including ranking data in said comparison data.

40. A notification method according to claim 38, including tracking user selections of said selectable links, and adjusting said ranking data based on said tracked user selections.

41. A notification method according to claim 25, including tracking interactions by users in response to the display of said notification data, storing tracking data, and modifying said notification data for a said user in response to the stored tracking data.

42. A notification client method to receive product or service comparison notification data from a notification system, the method comprising:
communicating with the client notification system over a network to receive the notification data;
storing said notification data comprising data comparing products or services;
generating an alert to a user when said notification data is received;
allowing a user to view said notification data, and to enter a selection of a product or service; and
transmitting said selection to said notification system.

43. A notification client method according to claim 42, including receive at least one of user data related to a user, type data identifying at least one type of product or service of interest to the user, parameter data comprising parameters required for the comparison of data for products or services of a product or service type of interest to the user, and temporal data indicative of when the user requires a notification; and transmitting said at least one of user data, type data, parameter data and temporal data to said notification system.

44. A notification client method according to claim 42, including storing said selections, detecting when communicate is not possible with said notification system, and operating in an off-line mode whereby said selections are stored until communication is possible with said notification system.

45. A notification client method according to claim 42, including storing said selections and said at least one of user data, type data, parameter data and temporal data, detecting when communicate is not possible with said notification system, and operating in an off-line mode whereby said selections and said at least one of user data, type data, parameter data and temporal data are stored until communication is possible with said notification system.

46. A notification method to provide a notification of comparison data for products or services to users for display on a user device, the method comprising:
storing user notification data for each of a plurality of users, the user notification data comprising user data identifying a type of notification required by a user, type data identifying at least one type of product or service of interest to the user, parameter data comprising parameters required for the comparison of data for products or services of a product or service type of interest to the user, and temporal data indicative of when the user requires a notification;
reading the user notification data to determine when to determine product or service comparison data by sending a query based on the type data and parameter data to at least one product or service data source;
generating notification data for display at a user device, said notification data including said comparison data; and
transmitting said notification data for each said user in dependence upon the type of notification defined in the user data.

47. A notification method according to claim 46, including generating said notification data to include selectable links in said comparison data, said selectable links including data for directing the user device to request said product or service.

48. A notification method according to claim 46, wherein said type of notification comprises one of a text message, an email, and a web page.

49. A comparison system for providing a comparison of products or services to users, the system comprising:
a comparison arrangement to determine product or service comparison data by comparing data on products or services;
a display generation arrangement to generate display data for display, said display data including said comparison data and a selectable link for each product or service compared in said comparison data, said selectable link sending a request for said product or service; and
a monitoring arrangement to monitor selections of said selectable links by users for said comparison data;
wherein said comparison arrangement is adapted to modify the determination of said comparison data in dependence upon said monitored selections.

50. A comparison method to provide a comparison of products or services to users, the method comprising:
determining product or service comparison data by comparing data on products or services;
generating display data for display, said display data including said comparison data and a selectable link for each product or service compared in said comparison data, said selectable link sending a request for said product or service; and
monitoring selections of said selectable links by users for said comparison data;
wherein the determination of said comparison data is modified in dependence upon said monitored selections.

51. A comparison system for providing a comparison of products or services to users, the system comprising:
a comparison arrangement to determine product or service comparison data by comparing data on products or services;
a display generation arrangement to generate display data for display, said display data including said comparison data and a selectable link for each product or service compared in said comparison data, said selectable link sending a request for said product or service; and
a monitoring arrangement to monitor selections of said selectable links by users for said comparison data;
wherein said display generation arrangement is adapted to modify the generation of said display data in dependence upon said monitored selections.

52. A comparison method to providing a comparison of products or services to users, the method comprising:
determining product or service comparison data by comparing data on products or services;
generating display data for display, said display data including said comparison data and a selectable link for each product or service compared in said comparison data, said selectable link sending a request for said product or service; and
monitoring selections of said selectable links by users for said comparison data;
wherein the generation of said display data is modified in dependence upon said monitored selections.

53. A storage medium storing computer readable code for controlling a computer to carry out the method of claim 25.

54. A storage medium storing computer readable code for controlling a computer to carry out the method of claim 42.

55. A storage medium storing computer readable code for controlling a computer to carry out the method of claim 46.

56. A storage medium storing computer readable code for controlling a computer to carry out the method of claim 50.

57. A storage medium storing computer readable code for controlling a computer to carry out the method of claim 52.
